(19) United States
(12) Patent Application Publication
(10) Pub. No.: US 2007/0240776 A1
(43) Pub. Date: Oct. 18, 2007

(54) Hydraulic pressure control system for automatic transmission device

(75) Inventor: Hiroyuki Mizui, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/727,894

(22) Filed: Mar. 28, 2007

(30) Foreign Application Priority Data
Mar. 31, 2006 (JP) 2006-98342

(51) Int. Cl. F16K 11/07

(52) U.S. Cl. 137/625.69

(57) ABSTRACT

In a hydraulic pressure control system for a vehicle automatic transmission device, an electric pump is provided in addition to a mechanical pump for generating hydraulic pressure, so that the hydraulic pressure can be continuously supplied to friction coupling elements even during the idling stop operation. A hydraulic pressure line for the electric pump is provided independently from a hydraulic pressure line for the mechanical pump. The hydraulic pressure of the electric pump is applied to the hydraulic pressure line for the mechanical pump shortly before a pressure control valve, which controls the hydraulic pressure to be applied to the friction coupling element.

### CROSS REFERENCE TO RELATED APPLICATION

This application is based on Japanese Patent Application No. 2006-98342, which is filed on Mar. 31, 2006, the disclosure of which is incorporated herein by reference.

### FIELD OF THE INVENTION

The present invention relates to a hydraulic pressure control system for an automatic transmission device of a vehicle.

### BACKGROUND OF THE INVENTION

Conventional systems will be explained with reference to FIGS. 6A and 6B.

An automatic transmission device for a vehicle has a friction coupling device C (a hydraulic clutch, a hydraulic brake, and so on) for carrying out a change-over operation of a gear change.

The friction coupling device C carries out a switching operation between a coupled condition of two members (a rotating member and another rotating member, or a rotating member and a fixed member) and a de-coupled condition of the two members, by a hydraulic actuator (a hydraulic servo). The coupling or de-coupling of the friction coupling device C is carried out by controlling hydraulic pressure for the hydraulic actuator with a pressure regulating valve F.

The hydraulic pressure applied to the friction coupling device C (more exactly, applied to the hydraulic actuator of the friction coupling device C) through the pressure regulating valve F is generally generated by a mechanical pump A, which is mechanically driven by an engine. Accordingly, the mechanical pump A does not generate the hydraulic pressure, when the engine operation is stopped in a vehicle having a function of an idling stop operation.

Therefore, an electric pump H is proposed to cover the situation, in which the hydraulic pressure by the mechanical pump is insufficient, for example, as disclosed in Japanese Patent Publication Nos. 2002-195399 and 2002-21993.

In the hydraulic control system of JP Patent Publication No. 2002-195399, as shown in FIG. 6A, the working oil is supplied from the electric pump H to the hydraulic control unit D through the same hydraulic line to the mechanical pump A. Therefore, the working oil discharged from the electric pump H flows through long hydraulic lines in the hydraulic control unit D, which are common to the oil discharged from the mechanical pump A. Accordingly, a relatively large amount of the oil leaks through a number of line pressure switching valves in the hydraulic control unit D.

It is, therefore, necessary for the electric pump H to generate the hydraulic pressure, which is obtained by adding “the hydraulic pressure for compensating a pressure decrease amount caused by the leakage of the oil in the hydraulic control unit D” to “the hydraulic pressure necessary for operating the friction coupling device C”. As a result, a large pump capacity is required for the electric pump H. It is, therefore, a problem in that a size of the electric pump H becomes larger and electric power consumption becomes higher.

According to the hydraulic control system of JP Patent Publication No. 2002-21993, as shown in FIG. 6B, the hydraulic pressure discharged from the electric pump H is directly supplied to the friction coupling device C through a selection valve S, so that the electric pump H of a smaller size and a lower consumption of the electric power is used.

The selection valve S is such a valve, which communicates a high pressure side, between the mechanical pump A and the electric pump H, with the friction coupling device C, and closes a low pressure side. It may, however, happen that the friction coupling device C is changed from a de-coupled condition to a coupled condition, in spite that the friction coupling device C should be held in the de-coupled condition, in the case that a malfunction occurs in the electric pump H or the hydraulic pressure is rapidly increased due to a breakdown of the electric pump H. When it happens, the condition of the gear change may be switched from one position to another, and the vehicle may move against a driver's intension when the engine is re-started.

### SUMMARY OF THE INVENTION

The present invention is made in view of the above problems. It is an object of the present invention to provide a hydraulic pressure control system for an automatic transmission device of a vehicle, in which the pump capacity for the electric pump can be suppressed to a small amount, and the friction coupling device may not be unintentionally coupled even if the hydraulic pressure discharged from the electric pump is rapidly increased due to any unexpected factors.

According to a feature of the present invention, a hydraulic pressure control system for an automatic transmission device of a vehicle has: a mechanical pump mechanically driven by an engine of the vehicle to generate hydraulic pressure; and a hydraulic control unit for applying the hydraulic pressure generated by the mechanical pump to friction coupling elements of the automatic transmission device, in order to carry out a gear change operation.

The hydraulic control unit has: pressure control valves for controlling the hydraulic pressure to be applied from the hydraulic control unit to the respective friction coupling elements; and a first hydraulic pressure line for supplying the hydraulic pressure generated at the mechanical pump to the respective pressure control valves.

The hydraulic control unit further has: an electric pump electrically operated to generate hydraulic pressure; a second hydraulic pressure line independently provided from the first hydraulic pressure line and for directly supplying the hydraulic pressure generated at the electric pump to the first hydraulic pressure line at such positions, which are close to and at upstream sides of the pressure control valves; and a backflow preventing device for preventing backflow of working fluid discharged from the electric pump to a side of the mechanical pump through the first hydraulic pressure line, and for preventing backflow of working fluid discharged from the mechanical pump to a side of the electric pump through the second hydraulic pressure line.

According to another feature of the present invention, the hydraulic pressure generated at the electric pump is applied to such pressure control valves through the hydraulic pressure line, which is selected by a manual valve operated by a vehicle driver.

According to a further feature of the present invention, the hydraulic pressure line has: D-side pressure lines for applying the hydraulic pressure generated at the electric pump to the pressure control valves to be connected to the friction coupling elements, which realize the first stage of the gear change for a forward movement of the vehicle when the friction coupling elements are brought into coupled conditions; and an R-side pressure line for applying the hydraulic pressure generated at the electric pump to the pressure control valve to be connected to the friction coupling element, which realizes the first stage of the gear change for a backward movement of the vehicle when the friction coupling element is brought into a coupled condition.

According to a still further feature of the present invention, the D-side pressure lines and the R-side pressure line are closed, when the manual valve is shifted to a position of P or N range.

### BRIEF DESCRIPTION OF THE DRAWINGS

The above and other objects, features and advantages of the present invention will become more apparent from the following detailed description made with reference to the accompanying drawings. In the drawings:

FIGS. 1A and 1B are respectively schematic diagrams showing a hydraulic pressure control system for an automatic transmission device of a vehicle;

FIG. 2 is a schematic diagram showing a hydraulic pressure control system, in which an oil pressure control valve of a direct control type is used;

FIG. 3 is a table showing coupling conditions for first to fifth friction coupling devices in the respective positions of a shift lever;

FIGS. 4A to 4D are schematic diagrams showing hydraulic lines for the respective positions of the shift lever;

FIG. 5A is a schematic cross sectional view showing a hydraulic pressure control valve having a spool valve;

FIG. 5B is a schematic cross sectional view showing a hydraulic pressure control valve having a ball valve; and

FIGS. 6A and 6B are schematic diagrams respectively showing a conventional hydraulic pressure control system for an automatic transmission device of a vehicle.

### DETAILED DESCRIPTION OF THE PREFERRED EMBODIMENTS

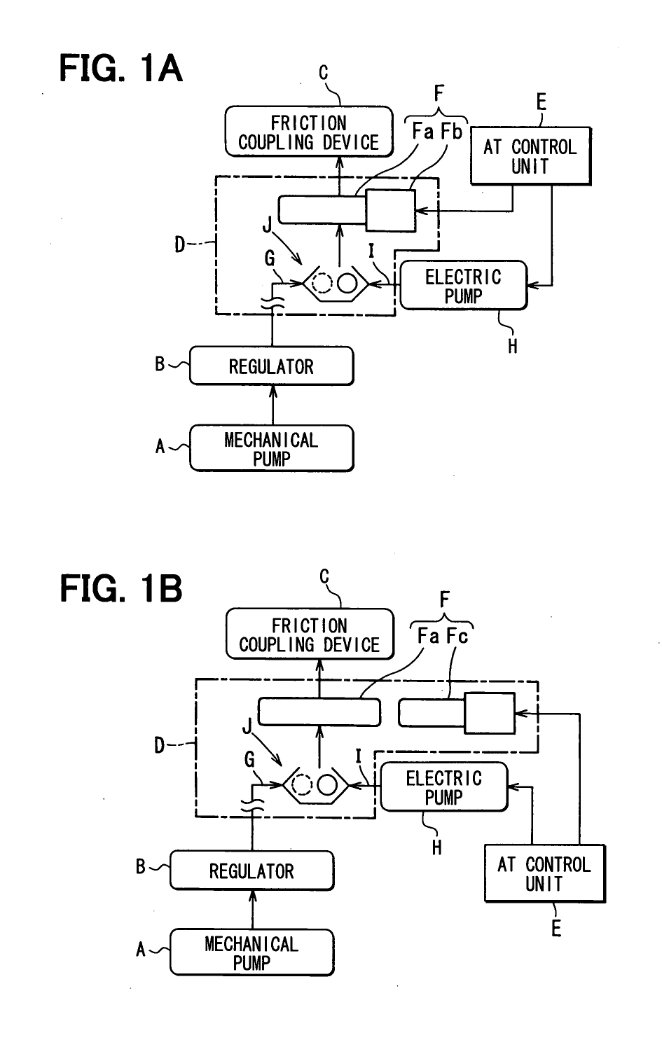

An embodiment of the present invention will be explained with reference to the drawings. As shown in FIGS. 1A and 1B, a hydraulic pressure control system for an automatic transmission device of a vehicle has a mechanical pump A which is mechanically driven by an engine of the vehicle to generate the hydraulic pressure. The hydraulic pressure control system further has a regulator (a pressure regulating valve) B for controlling the hydraulic pressure discharged from the mechanical pump A at a predetermined regulating pressure, a hydraulic control unit D for controlling the hydraulic pressure to be applied to a friction coupling device C (having a hydraulic clutch, a hydraulic brake, and so on), which carries out a gear change, and an automatic transmission control unit E (hereinafter referred to as an AT control unit) for controlling current supply to electrical components mounted in the hydraulic control unit D.

The hydraulic control unit D has a pressure control valve F for supplying the hydraulic pressure generated at the mechanical pump A to the friction coupling device C or discharging the supplied hydraulic pressure from the friction coupling device C. It also has a hydraulic pressure line G for the mechanical pump A for supplying the hydraulic pressure generated at the mechanical pump A to the pressure control valve F.

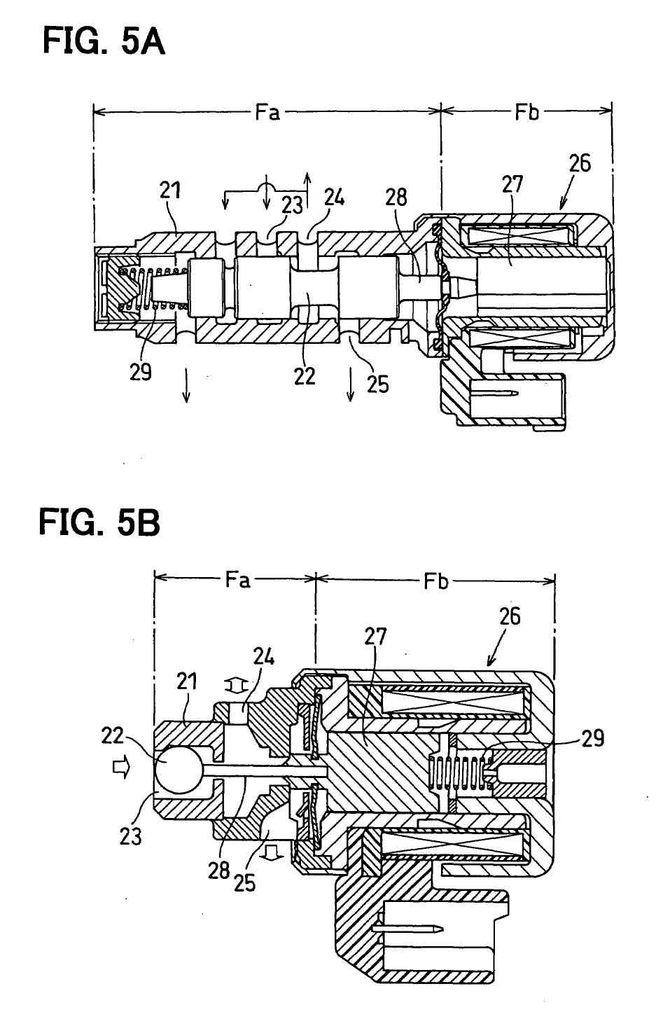

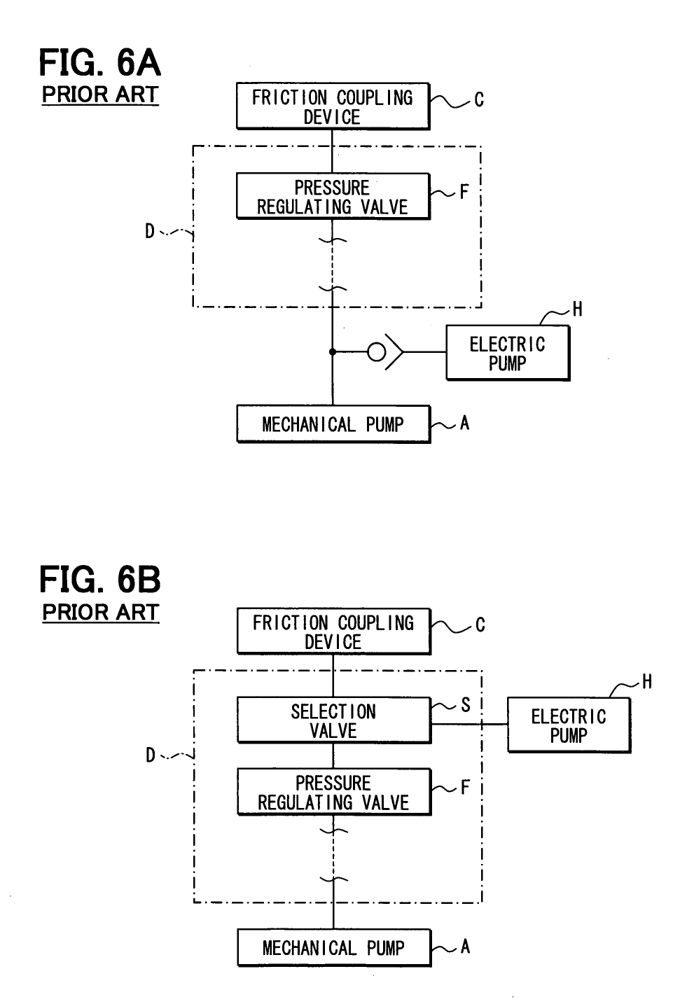

In the hydraulic pressure control system shown in FIG. 1A, a hydraulic pressure control valve of a direct control type is used as the pressure control valve F, wherein a valve body 22 (see FIGS. 5A and 5B) of a valve unit Fa is directly driven by an electric actuator Fb. The valve unit Fa controls the hydraulic pressure to be applied to the friction coupling device C.

On the other hand, in the hydraulic pressure control system shown in FIG. 1B, a hydraulic pressure control valve of a pilot control type is used as the pressure control valve F, wherein the valve body 22 (see FIGS. 5A and 5B) of the valve unit Fa is driven by hydraulic pressure generated by a pilot valve Fc. The valve unit Fa controls the hydraulic pressure to be applied to the friction coupling device C, as in the same manner to FIG. 1A.

The hydraulic pressure control system further has an electric pump H, which is electrically operated by the AT control unit E to generate hydraulic pressure, which is used when the generated hydraulic pressure of the mechanical pump A is not sufficiently high, or when the engine operation is temporally stopped as a result of the idling stop operation.

The hydraulic pressure control system has a hydraulic pressure line I for the electric pump H, which is independently provided from the hydraulic pressure line G for the mechanical pump A, for directly supplying the hydraulic pressure generated at the electric pump H to the hydraulic pressure line G at such a point, which is close to and at an upstream side of the pressure control valve F.

Furthermore, the hydraulic pressure control system has a backflow preventing means (or device) J, which prevents a backflow of the hydraulic pressure generated at the electric pump H to a side of the mechanical pump A through the hydraulic pressure line G and also prevents a backflow of the hydraulic pressure generated at the mechanical pump A to a side of the electric pump H through the hydraulic pressure line I.

According to the above hydraulic pressure control system, the leakage of the hydraulic pressure generated by the electric pump H and leaked in the hydraulic control unit D can be suppressed, so that the electric pump H can be made smaller and the power consumption of the electric pump H becomes lower. Furthermore, the hydraulic pressure generated by the electric pump H is applied to the hydraulic pressure line G for the mechanical pump A at such a point, which is close to the pressure control valve F and at the upstream side thereof. Accordingly, the problem, in which the friction coupling device C may be accidentally brought into the coupled condition, can be avoided even when the hydraulic pressure discharged from the electric pump H is rapidly increased due to the malfunction or breakdown of the electric pump H.

The backflow preventing device J is provided at a junction of the hydraulic pressure line G for the mechanical pump A and the hydraulic pressure line I for the electric pump H. The backflow preventing device J is a selection valve, which communicates the hydraulic pressure, whichever is higher than the other between the hydraulic pressure from the mechanical pump A and the hydraulic pressure from the electric pump H, with the pressure control valve F. The backflow preventing device J (the selection valve) closes either one of the hydraulic pressure line G or I, the hydraulic pressure of which is lower than the other.

The engine for the vehicle, to which the present invention is applied, may be an internal combustion engine, a hybrid type engine in which an internal combustion engine is combined with an electric motor.

The number of the friction coupling device C of the present invention may not be limited to one. In the case that the hydraulic pressure control system has multiple friction coupling devices C, the present invention may be applied to all of the friction coupling devices C or to a part of the multiple friction coupling devices C.

The backflow preventing device J (the selection valve) may be formed from one valve, or formed by multiple valves. The backflow preventing device J may be alternatively formed by any line pressure switching valve(s), which is (are) provided in the hydraulic control unit D for such line pressure switching operation, and which is (are) controlled to be closed or opened. Furthermore, the backflow preventing device J may be such a device (or a valve), which is automatically operated by hydraulic pressure, or which is operated by an electric actuator (such as, an electromagnetic actuator) controlled by the AT control unit E.

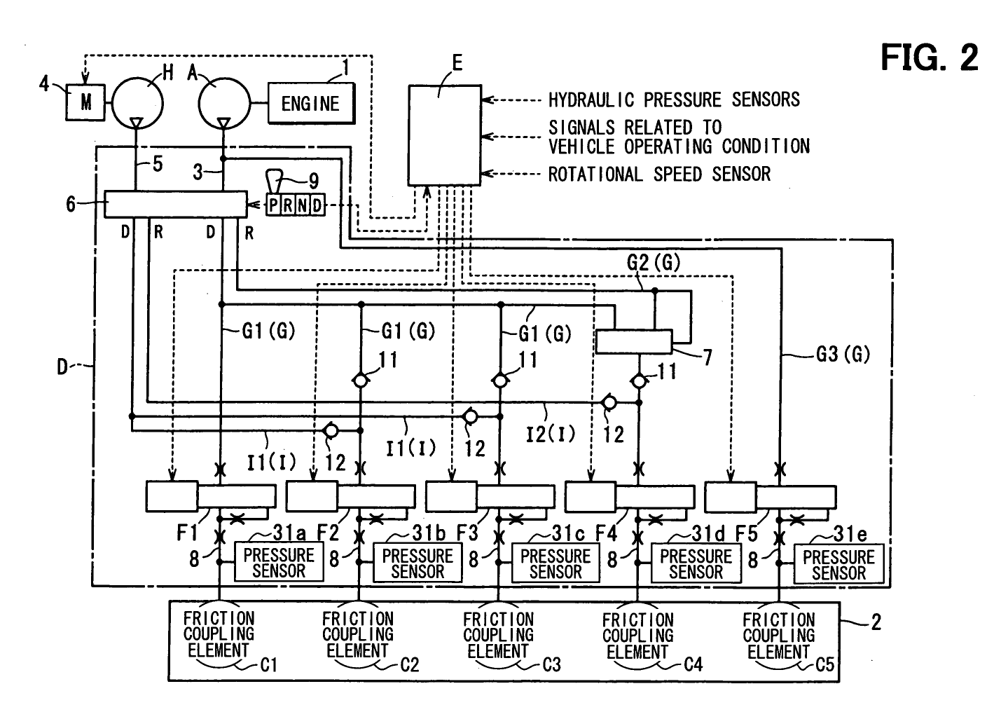

More details will be explained with reference to FIG. 2 to FIGS. 5A and 5B.

The automatic transmission device changes a speed reduction ratio of a rotational driving force generated by the engine 1, and changes the rotational direction of the driving force. The automatic transmission device has a hydraulic coupling (a torque converter, and the like), a transmission 2 having multiple planetary gear trains, multiple (first to fifth) friction coupling devices C1 to C5 (each having a multiplate hydraulic clutch, a multiplate hydraulic brake) for carrying out gear changes for the transmission 2, and a control unit for controlling the coupling and de-coupling of the friction coupling devices.

Each of the first to fifth friction coupling devices C1 to C5 provided in the transmission 2 carries out a switching operation between a coupled condition of friction coupling elements (e.g. the multiplate clutch, and multiplate brake, etc.) provided in two members (a rotating member and another rotating member, or a rotating member and a fixed member) and a de-coupled condition of the friction coupling elements, by a hydraulic actuator (a hydraulic servo). The friction coupling elements are coupled when the hydraulic pressure of the hydraulic actuator is increased, whereas the friction coupling elements are de-coupled when the hydraulic pressure of the hydraulic actuator is decreased.

The first to fifth friction coupling devices C1 to C5 are switched to the coupled condition or to the de-coupled condition in accordance with the hydraulic pressure, respectively applied from the hydraulic control unit D.

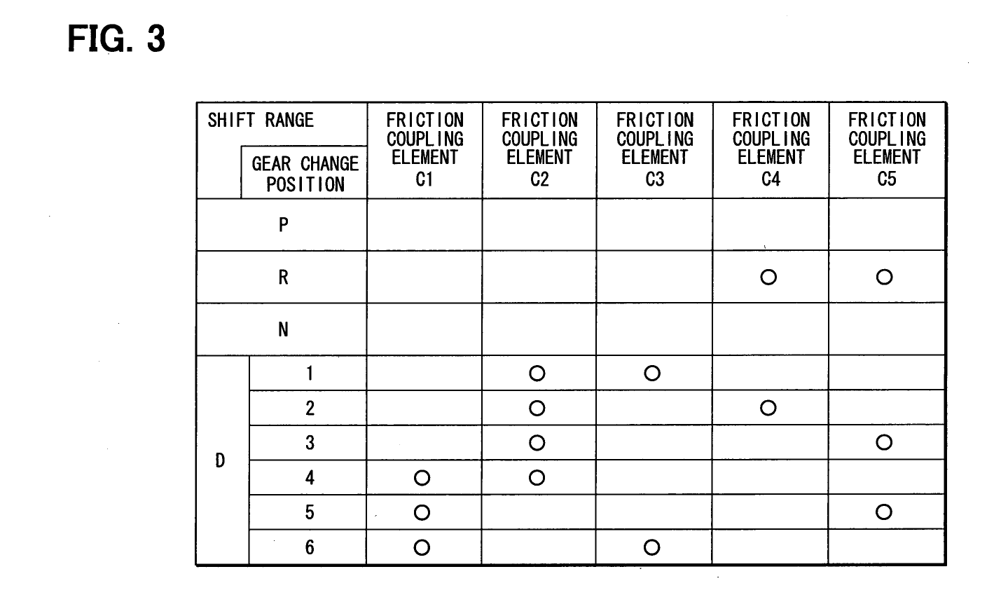

Shift ranges (positions of the shift lever) of the automatic transmission device has P range (a parking range), R range (a reverse range), N range (a neutral range), and D range (a drive range). In the embodiment, there are six gear change positions in the D range, and one gear change position in the R range. Those shift ranges and gear change positions are realized by combinations of the coupled and de-coupled conditions of the respective friction coupling elements C1 to C5, as shown in FIG. 3. In FIG. 3, a circle designates the friction coupling element, which will be coupled to achieve the desired the shift range and gear change position. For example, the second and third friction coupling elements C2 and C3 are coupled, when the shift lever is in the first gear change position of the D range. The fourth and fifth friction coupling elements C4 and C5 are coupled, when the shift lever is in the R range (the first gear change position of the R range).

The hydraulic pressure control system controls the shift range and the gear change position by controlling the hydraulic pressure to be applied to the respective friction coupling devices (elements) C1 to C5, by use of the hydraulic pressure supplied from the hydraulic pressure generating source (e.g. the mechanical pump A). For that purpose, the hydraulic pressure control system has, in addition to the hydraulic pressure generating source, the hydraulic control unit D in which hydraulic circuits are formed, and the AT control unit E for controlling current supply to electrical components mounted in the hydraulic control unit D.

The hydraulic pressure control system according to the present embodiment is mounted in the vehicle having the idling stop operation, and therefore the system has the electric pump H in addition to the mechanical pump A.

The mechanical pump A is mechanically driven by the rotational driving force of the engine 1 to generate the hydraulic pressure. More exactly, a driving shaft of the mechanical pump A is mechanically connected to an output shaft of the engine 1. The mechanical pump A is driven to rotate upon receiving the rotational driving force of the engine 1, in order to suck working fluid from an oil pan and to supply the working fluid to a first oil inlet line 3, which is formed in the hydraulic control unit D. Accordingly, the mechanical pump A starts the discharge (the pumping operation) of the working fluid together with the operation of the engine 1, and stops the supply of the working fluid when the engine operation is stopped.

A discharge amount of the working fluid and the hydraulic pressure of the mechanical pump A are influenced by the rotational speed of the engine 1. Therefore, the hydraulic pressure of the mechanical pump A is controlled by the regulator B (not shown in FIG. 2) at the predetermined regulating pressure, and then such regulated hydraulic pressure is applied to the hydraulic control unit D.

The electric pump H is electrically driven to generate the hydraulic pressure.

More exactly, the electric pump H has an electric motor 4 for generating rotational driving force upon receiving electric power, so that it sucks the working fluid from the oil pan when the electric power is supplied to the electric pump H in order to supply the working fluid to a second oil inlet line 5, which is also formed in the hydraulic control unit D. Accordingly, the electric pump H starts the discharge (the pumping operation) of the working fluid upon receiving the driving current (the electric power) from the AT control unit E, and stops the supply of the working fluid when the supply of the electric power is cut off.

A discharge amount of the working fluid and the hydraulic pressure of the electric pump H are controlled by the driving current from the AT control unit E.

The hydraulic control unit D is a hydraulic circuit for respectively controlling the hydraulic pressure to be applied to the first to fifth friction coupling devices (elements) C1 to C5. The hydraulic control unit D has a manual valve 6 to be operated by a vehicle driver, first to fifth pressure control valves F1 to F5 respectively provided for the first to fifth friction coupling devices (elements) C1 to C5, and a switching valve 7.

Furthermore, the hydraulic control unit D has the hydraulic pressure line G for the mechanical pump (D-side pressure lines G1, an R-side pressure line G2, and an independent pressure line G3), for supplying the hydraulic pressure of the mechanical pump A to the first to fifth pressure control valves F1 to F5. The hydraulic control unit D further has the hydraulic pressure line I for the electric pump (D-side pressure lines I1, and an R-side pressure line I2). The hydraulic pressure line I is provided independently from the hydraulic pressure line G for the mechanical pump, for supplying the hydraulic pressure of the electric pump H to the second to fourth pressure control valves F2 to F4. And output pressure lines 8 are provided for respectively communicating the first to fifth pressure control valves F1 to F5 with the first to fifth friction coupling devices (elements) C1 to C5.

The manual valve 6 is a spool valve electrically or mechanically connected to a range selector 9 (a lever type, such as the shift lever, a button type, or the like) operated by the vehicle driver. The manual valve 6 has a first manual valve for switching over the hydraulic pressure from the mechanical pump A through the first oil inlet line 3 either to the D-side pressure lines G1 or to the R-side pressure line G2. The manual valve 6 has a second manual valve for likewise switching over the hydraulic pressure from the electric pump H through the second oil inlet line 5 either to the D-side pressure lines I1 or to the R-side pressure line I2.

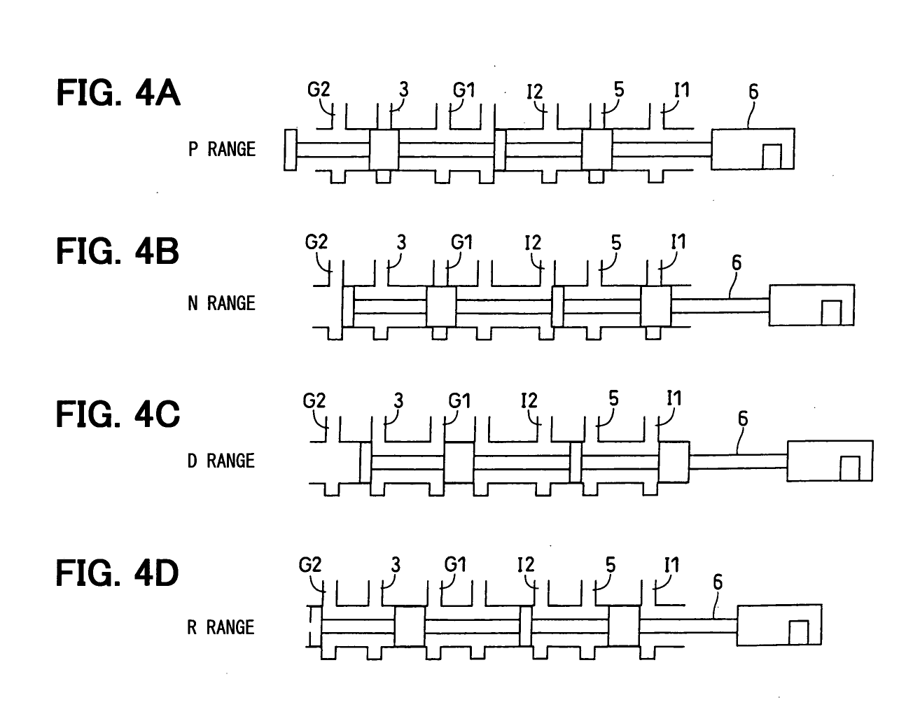

The manual valve 6, which has the above first and second manual valves integrally formed with each other, selects the hydraulic pressure lines for opening and closing in accordance with the position of the range selector 9, as shown in FIGS. 4A to 4D.

The hydraulic pressure line G has the D-side pressure lines G1 for supplying the hydraulic pressure of the mechanical pump A (which is supplied to the manual valve 6 through the first oil inlet line 3) to the first to fourth pressure control valves F1 to F4, which are selected by the manual valve 6. The hydraulic pressure line G has the R-side pressure line G2 for supplying the hydraulic pressure of the mechanical pump A (which is supplied to the manual valve 6 through the first oil inlet line 3) to the fourth pressure control valve F4. The hydraulic pressure line G further has the independent pressure line G3 for supplying the hydraulic pressure of the mechanical pump A (which is supplied through the first oil inlet line 3) to the fifth pressure control valve F5.

The switching valve 7 is a spool valve operated by a spring, for switching over the hydraulic pressure to be applied to the fourth pressure control valve F4 either to the D-side pressure line G1 or to the R-side pressure line G2.

Switching positions of the switching valve 7 are changed by a balance between the hydraulic pressure in the R-side pressure line G2 and a spring force, such that the hydraulic pressure of the D-side pressure line G1 is supplied to the fourth pressure control valve F4 when the hydraulic pressure in the R-side pressure line G2 becomes lower than a predetermined pressure. In other words, the hydraulic pressure in the R-side pressure line G2 is supplied to the fourth pressure control valve F4 when the hydraulic pressure in the R-side pressure line G2 becomes higher than the predetermined pressure.

The hydraulic pressure line I for the electric pump H is provided independently from the hydraulic pressure line G for the mechanical pump. The hydraulic pressure line I has the D-side pressure lines I1 for supplying the hydraulic pressure of the electric pump H (which is supplied to the manual valve 6 through the second oil inlet line 5) directly to the D-side pressure lines G1 connected to the second and third pressure control valves F2 and F3, which are selected by the manual valve 6. The hydraulic pressure of the D-side pressure lines I1 is applied to the respective D-side pressure lines G1 at such positions, which are immediately before (that is, close to upstream sides of) the pressure control valves F2 and F3.

Furthermore, the hydraulic pressure line I has the R-side pressure lines I2 for supplying the hydraulic pressure of the electric pump H (which is supplied to the manual valve 6 through the second oil inlet line 5) directly to the hydraulic pressure line G (either to the D-side pressure line G1 or the R-side pressure line G2, which is selected by the switching valve 7) connected to the fourth pressure control valve F4, which is selected by the manual valve 6. The hydraulic pressure of the R-side pressure lines I2 is applied to the hydraulic pressure line G (to the D-side pressure line G1 or the R-side pressure line G2) at such a position, which is immediately before (that is, close to an upstream side of) the pressure control valve F4.

The backflow preventing device J is provided in the hydraulic control unit D, as explained with reference to FIGS. 1A and 1B, which prevents the backflow of the hydraulic pressure generated at the electric pump H to the side of the mechanical pump A (that is the side of the first manual valve) through the hydraulic pressure line G, and which also prevents the backflow of the hydraulic pressure generated at the mechanical pump A to the side of the electric pump H (that is the side of the second manual valve) through the hydraulic pressure line I.

The backflow preventing device J in this embodiment comprises first check valves 11 provided in the hydraulic pressure line G and second check valves 12 provided in the hydraulic pressure line I.

Each of the first check valves 11 is provided in the hydraulic pressure line G at an upstream side of a junction between the hydraulic pressure line G and the hydraulic pressure line I (namely, on a side of the first manual valve). The check valve 11 is a one way valve, which is closed by the hydraulic pressure in the hydraulic pressure line I (that is the hydraulic pressure generated by the electric pump H), so that the hydraulic pressure generated by the electric pump H is prevented from flowing to the side of the mechanical pump A through the hydraulic pressure line G.

Each of the second check valves 12 is provided in the hydraulic pressure line. The check valve 12 is likewise a one way valve, which is closed by the hydraulic pressure in the hydraulic pressure line G (that is the hydraulic pressure generated by the mechanical pump A), so that the hydraulic pressure generated by the mechanical pump A is prevented from flowing to the side of the electric pump H through the hydraulic pressure line I.

The first to fifth pressure control valves F1 to F5 are provided for the first to fifth friction coupling devices (elements) C1 to C5, for respectively controlling the hydraulic pressure to be applied to the first to fifth friction coupling devices (elements) C1 to C5. In the embodiment, the direct control type valve is used as the pressure control valve (F1 to F5), as shown in FIG. 5A or 5B.

The pressure control valve has a valve unit portion Fa for switching over the hydraulic pressure or controlling the hydraulic pressure, and an electric actuator Fb for driving the valve unit portion Fa. The spool valve is used in the valve unit portion Fa of FIG. 5A, whereas the ball valve is used in the valve unit portion Fa of FIG. 5B.

The valve unit portion Fa, having a valve housing 21 and a valve body 22, is inserted into a housing body (not shown) of the hydraulic control unit D.

The valve unit portion Fa has an inlet port 23 for receiving the hydraulic pressure, an outlet port 24 for supplying the hydraulic pressure to the friction coupling elements (C1 to C5), and a discharge port 25 for discharging the working fluid.

The valve body 22 moves in the inside of the valve housing 21 for controlling a communication degree of the respective ports 23, 24, and 25, so that the hydraulic pressure at the outlet port 24 is controlled.

The electric actuator Fb in the embodiment is an electromagnetic actuator having a solenoid 26 and a movable core 27.

The solenoid 26 has a coil for generating electromagnetic force upon receiving electric current, in order to axially move the movable core 27 by generating the electromagnetic force in accordance with the electric power supply from the AT control unit E. The movable core 27 moves the valve body 22 via a shaft 28.

The axial positions of the movable core 27 and the valve body 22 are controlled by the electric power supply to the solenoid 26 from the AT control unit E depending on an operational condition of the vehicle.

The communication degree between the inlet port 23 and the outlet port 24 as well as the communication degree between the outlet port 24 and the discharge port 25, and thereby a ratio between the above two communication degrees is controlled. As a result, the discharge pressure (the hydraulic pressure) at the outlet port 24 is controlled.

The pressure control valve of FIG. 5A is a normally closed type electromagnetic valve. The communication degree between the inlet port 23 and the outlet port 24 becomes minimum (closed), whereas the communication degree between the outlet port 24 and the discharge port 25 becomes maximum, by a biasing force of a spring 29, when the supply of the electric power to the electric actuator (the electromagnetic actuator) Fb is cut off. The pressure control valve of FIG. 5B is a normally opened type electromagnetic valve. The communication degree between the inlet port 23 and the outlet port 24 becomes maximum, whereas the communication degree between the outlet port 24 and the discharge port 25 becomes minimum (closed), by the biasing force of the spring 29, when the supply of the electric power to the electric actuator (the electromagnetic actuator) Fb is cut off.

The AT control unit E is an electronic control unit for controlling current supply to the respective electrical components (such as, the electric pump H, the first to fifth pressure control valves F1 to F5, and so on) mounted in the hydraulic control unit D. The AT control unit E comprises an AT-ECU (electronic control unit) and an AT-EDU (electronic drive unit).

The AT-ECU generally includes a well-known computer having CPU for carrying out processes and calculations, a memory device (such as, ROM, RAM, SRAM, EEPROM, and so on) for storing various programs and data, input circuits, output circuits, and a power supply circuit, wherein the AT-ECU performs the calculating process based on signals from sensors.

The sensor signals (such as, an opening degree of an acceleration pedal, a rotational speed of the engine, the temperature of the engine cooling water, the position of the shift lever, the braking condition, pressure sensors 31a to 31e for detecting the hydraulic pressures to be applied to the respective friction coupling elements C1 to C5, and so on), which represent the operating condition of the vehicle, are inputted to the AT-ECU directly from the sensors or indirectly via an engine ECU.

The AT-EDU has a circuit for applying the driving current (the electric current for controlling the communication degrees) to the first to fifth pressure control valves F1 to F5 based on the command signals from the AT-ECU, and a circuit for applying the driving current (the electric current for controlling the rotational speed) to the electric pump H based on the command signal from the AT-ECU.

The AT-ECU has a function for “the gear change control”, in which the communication degrees in the respective pressure control valves F1 to F5 are controlled in accordance with the operating condition of the vehicle. The AT-ECU has a further function for “the electric pump control”, in which the rotational speed (that is, the discharge pressure) of the electric pump H is controlled in accordance with the operating condition of the vehicle.

The “gear change control” is carried out by a well known control program to realize the shift range and the gear change position corresponding to the operating condition of the vehicle (including the idling stop operation). The current supply to the first to fifth pressure control valves F1 to F5 are controlled to carry out the coupled condition and/or de-coupled condition in the first to fifth friction coupling elements C1 to C5, as shown in FIG. 3 depending on the operating condition of the vehicle.

The “electric pump control” is carried out by a well known control program to realize the gear change position shown in FIG. 3 by operating the electric pump H, when the discharged hydraulic pressure of the mechanical pump A is insufficient during the start-up operation or the normal operation of the engine, or when the hydraulic pressure is necessary to realize the gear change position for starting up the engine operation in case of the idling stop operation.

The hydraulic pressure control system for the automatic transmission device according to the above embodiment has the following advantages.

The hydraulic pressure generated at the electric pump H is directly supplied to the hydraulic pressure line G at the position shortly before the pressure control valves F2 to F4, through the hydraulic pressure line I independently formed from the hydraulic pressure line G. Accordingly, the hydraulic pressure generated at the electric pump H is supplied, through the hydraulic pressure line I independently formed from the hydraulic pressure line G, to only such portion of the hydraulic control unit D, in which the hydraulic pressure is required.

In the above operation, the hydraulic pressure supplied to the hydraulic pressure line G at the position shortly before the pressure control valves F2 to F4 is prevented from flowing back to the side of the mechanical pump A by the first check valves 11. Accordingly, the problem, in which the leakage of the working fluid generated by the electric pump H occurs to the side of the mechanical pump A, is overcome.

As a result, it is possible to reduce an amount of the hydraulic pressure for compensating the pressure decrease amount caused by the leakage of the working fluid in the hydraulic control unit D. This means that the pump capacity for the electric pump H can be suppressed to a smaller amount, to realize a small sized and light weight electric pump H and to reduce the electric power consumption.

According to the above embodiment, the hydraulic pressure generated at the electric pump H is directly applied to either the hydraulic pressure line G at the position shortly before the pressure control valves F2 and F3 or at the position shortly before the pressure control valve F4, which are (is) selected by the manual valve 6 (more exactly, by the second manual valve). This means that the hydraulic pressure generated at the electric pump H is supplied not to all of the hydraulic pressure line I (the pressure lines I1 and I2), but to the hydraulic pressure line I selected by the manual valve 6 depending on the position of the shift lever. Therefore, the hydraulic pressure generated at the electric pump H is supplied through the D-side pressure lines I1 to the pressure control valves F2 and F3, when the shift lever is in the D range, whereas the hydraulic pressure generated at the electric pump H is supplied through the R-side pressure line I2 to the pressure control valve F4, when the shift lever is in the R range.

When the shift lever is in the P or N range, the D-side pressure lines I1 and the R-side pressure line I2 are closed by the manual valve 6.

As above, the hydraulic pressure is not supplied to the R-side pressure line I2 in case of the D range, and the hydraulic pressure is likewise not supplied to the D-side pressure line I1 in case of the R range. Accordingly, the working fluid discharged from the electric pump H can be effectively supplied to the necessary hydraulic pressure line I for the gear change operation. And the possible leakage of the working fluid to the hydraulic pressure line I (more exactly, to the pressure line I1 connected to the first pressure control valve F1), which is not necessary for the gear change operation, can be prevented.

As a result, it is further possible to reduce the amount of the hydraulic pressure for compensating the pressure decrease amount caused by the leakage of the working fluid in the hydraulic control unit D. This means that the pump capacity for the electric pump H can be furthermore suppressed to a smaller amount, to realize a smaller sized and lighter weight electric pump H and to reduce the electric power consumption.

The hydraulic pressure generated at the electric pump H is directly applied to the hydraulic pressure line G at the position shortly before the pressure control valves F2 to F4. Therefore, the hydraulic pressure to be applied to the friction coupling elements C2 to C4 is controlled by the pressure control valves F2 to F4.

Accordingly, the problem, in which the friction coupling elements C2 to C4 are accidentally changed from the de-coupled condition to the coupled condition, may not happen, even when the hydraulic pressure discharged from the electric pump H is rapidly increased due to the malfunction or the breakdown of the electric pump H.

In the above embodiment, the hydraulic pressure generated at the electric pump H is supplied to the D-side pressure line D1 when the shift lever is switched to the D range by the vehicle driver, whereas the hydraulic pressure generated at the electric pump H is supplied to the R-side pressure line I2 when the shift lever is switched to the R range. No hydraulic pressure is applied to the pressure line I, when the shift lever is switched to the P or N range.

Accordingly, the hydraulic pressure of the electric pump H may not be supplied to such friction coupling elements, which may cause the coupled condition different from that shifted (intended) by the vehicle driver, even when the hydraulic pressure discharged from the electric pump H is rapidly increased due to the malfunction or the breakdown of the electric pump H, and additionally when the malfunction of the pressure control valves F2 to F4 may happen to occur due to unexpected reasons. As a result, the shift range can be realized in accordance with the operation of the shift lever by the vehicle driver to maintain and improve the safety of the vehicle.

### (Modifications)

In the above embodiment, two independent check valves (the first check valves 11 and the second check valves 12) are used as the backflow preventing means J. However, the backflow preventing means J may be formed by one valve. Furthermore, in the above embodiment, the backflow preventing J is formed as such a valve, which is operated by the hydraulic pressure. However, such a valve, which may be operated by a spring force, can be alternatively used as the backflow preventing J, wherein the valve is opened when the hydraulic pressure exceeds a predetermined spring force.

In the above embodiment, the hydraulic pressure of the electric pump H is supplied to the hydraulic pressure line G immediately before the pressure control valves F2 to F4 through the manual valve 6. However, the hydraulic pressure of the electric pump H may be supplied to the hydraulic pressure line G immediately before the pressure control valves F2 to F4, without passing through the manual valve 6.

In the above embodiment, the electromagnetic valves are used as the electric actuators for the pressure control valves F1 to F5. However, other types of the electric actuators Fb, such as the electric motors, piezoelectric actuators, or the like, may be used.

Furthermore, in the above embodiment, the pressure control valve of the direct control type is used for the pressure control valves F1 to F5. However, the pressure control valve of the pilot control type may be used, in which the valve body 22 of the valve unit portion Fa for controlling the hydraulic pressure to be applied to the first to fifth friction coupling elements C1 to C5 is operated by the hydraulic pressure generated at the pilot valve Fc.

What is claimed is:

1. A hydraulic pressure control system for an automatic transmission device of a vehicle comprising:
a mechanical pump mechanically driven by an engine of the vehicle to generate hydraulic pressure; and
a hydraulic control unit for applying the hydraulic pressure generated by the mechanical pump to friction coupling elements of the automatic transmission device, in order to carry out a gear change operation,
wherein the hydraulic control unit comprises:
pressure control valves for controlling the hydraulic pressure to be applied from the hydraulic control unit to the respective friction coupling elements;
a first hydraulic pressure line for supplying the hydraulic pressure generated at the mechanical pump to the respective pressure control valves;
an electric pump electrically operated to generate hydraulic pressure;
a second hydraulic pressure line independently provided from the first hydraulic pressure line and for directly supplying the hydraulic pressure generated at the electric pump to the first hydraulic pressure line at such positions, which are close to and at upstream sides of the pressure control valves; and
a backflow preventing device for preventing backflow of working fluid discharged from the electric pump to a side of the mechanical pump through the first hydraulic pressure line, and for preventing backflow of working fluid discharged from the mechanical pump to a side of the electric pump through the second hydraulic pressure line.

2. A hydraulic pressure control system according to claim 1, wherein
the hydraulic pressure generated at the electric pump is applied to such pressure control valves through the hydraulic pressure line, which is selected by a manual valve operated by a vehicle driver.

3. A hydraulic pressure control system according to claim 2, wherein
the hydraulic pressure line comprises:
D-side pressure lines for applying the hydraulic pressure generated at the electric pump to the pressure control valves to be connected to the friction coupling elements, which realize the first stage of the gear change for a forward movement of the vehicle when the friction coupling elements are brought into coupled conditions; and
an R-side pressure line for applying the hydraulic pressure generated at the electric pump to the pressure control valve to be connected to the friction coupling element, which realizes the first stage of the gear change for a backward movement of the vehicle when the friction coupling element is brought into a coupled condition.

4. A hydraulic pressure control system according to claim 3, wherein
the D-side pressure lines and the R-side pressure line are closed, when the manual valve is shifted to a position of P or N range.
